(19) United States
(12) Patent Application Publication
(10) Pub. No.: US 2021/0325235 A1
(43) Pub. Date: Oct. 21, 2021

(54) APPARATUS AND METHOD FOR A YIELD IMPROVEMENT SYSTEM

(71) Applicants: Dmitry Taveren, McCormick, SC (US); David Cravens, Washington, GA (US); Amato Spagnoletti, Ramsey, NJ (US)

(72) Inventors: Dmitry Taveren, McCormick, SC (US); David Cravens, Washington, GA (US); Amato Spagnoletti, Ramsey, NJ (US)

(21) Appl. No.: 17/231,681

(22) Filed: Apr. 15, 2021

Related U.S. Application Data
(60) Provisional application No. 63/010,147, filed on Apr. 15, 2020.

(51) Int. Cl. G01G 15/00; G01G 21/22; G01G 23/00

(52) U.S. Cl. CPC G01G 15/001; G01G 2015/003; G01G 23/007; G01G 21/22

(57) ABSTRACT

A yield improvement system adapted to weigh an object including a weighing device having a holder that is adapted to removably receive the object to be weighed and a load sensor that is adapted to determine the weight of the object to be weighed. The yield system also includes a programmable logic controller that is in electrical communication with the weighing device, a cloud platform that is in electrical communication with the programmable logic controller, and an application program interface (API) that is in electrical communication with the cloud platform, and a means for removably attaching the weighing device to an anchoring device. A method comprising providing a yield improvement system and weighing an object.

### CROSS-REFERENCES TO RELATED APPLICATIONS/PATENTS

This application relates back to and claims the benefit of priority from U.S. Provisional Application for Patent Ser. No. 63/010,147 titled “System and Method for Improving the Yield in Food Servings” and filed on Apr. 15, 2020.

### FIELD OF THE INVENTION

The present invention relates generally to apparatuses and methods for improving the yield and accuracy of food servings and other materials apportioning applications, and particularly to apparatuses and methods for automatically acquiring and processing the yield and accuracy of food servings.

### BACKGROUND AND DESCRIPTION OF THE PRIOR ART

It is known to use apparatuses and methods to control the apportionment of food servings in a food service restaurant. Conventional apparatuses and methods, however, suffer from one or more disadvantages. For example, some conventional systems attempt to use commercially available mechanical or digital scales installed in proximity to the food serving preparation area to weigh each comestible that needs to be applied to the food serving, but these conventional systems fail to meet the needs of the industry because operators have difficulty accurately and consistently dispensing exact amounts of various required portions, struggle with manual taring or weight subtraction calculations, and in many cases ignore scale usage because it delays and complicates production process/flow.

Other conventional systems attempt to embed or integrate a weigh scale into food preparation equipment, but these conventional systems are similarly unable to meet the needs of the industry.

These imbedded conventional systems make it difficult for operators to calculate and interpret correct portion sizes and typically do not provide visibility into apportionment performance. Also, often times these conventional systems are difficult to implement via retrofitting existing equipment, and therefore tend to be more costly and/or less effective.

In addition, other conventional systems include a digital scale that can be mounted on the existing equipment, but these conventional systems also fail to meet industry needs because they are unable to automatically detect the size of food container, do not tare and adjust to zero automatically, and do not utilize cloud data processing and analytics to provide critical information such as apportionment performance, consistency of operator usage, and economics/savings associated with improved efficiency and accuracy.

Quick-service and commercial restaurants have food items on the menu that include partial (or in whole) specific and standard amounts of comestibles. Typically, when food items are being prepared for serving, operators will dispense the required amount of comestible visually, trusting their own individual judgement. This approach leads to over-filling or under-filling the food serving, resulting in inconsistent portioning which can lead to customer dissatisfaction, as well as varying product usage and cost per serving which is very undesirable for management and owners.

It would be desirable, therefore, if an apparatus and method for a yield improvement system could be provided that would automatically monitor and analyze how accurately and efficiently each individual comestible/material is portioned in a food serving. It would also be desirable if such a system could be provided that would automatically generate corrective actions and information to improve the food serving yield and monitor operator usage/performance. It would be further desirable if such a system could be provided that would improve yield in other restaurant applications such as calibration of liquid dispensers (e.g., shake machines) by weight and measuring baking/cooking ingredients. It would be still further desirable if such a system could be provided that would seamlessly integrate into existing food serving and materials handling equipment and processes without affecting the existing food serving equipment and processes.

### ADVANTAGES OF THE PREFERRED EMBODIMENTS OF THE INVENTION

Accordingly, it is an advantage of the preferred embodiments of the invention claimed herein to provide an apparatus and method for a yield improvement system that automatically monitors and analyzes how accurately and efficiently each individual comestible/material is portioned in a food serving or other materials portion. It is also an advantage of the preferred embodiments of the system to automatically generate corrective actions and information to improve the food serving yield or other material portion and monitor operator usage/performance. It is a further advantage of the preferred embodiments of the system to improve yield and accuracy in other restaurant applications such as calibration of liquid dispensers (e.g., shake machines) by weight and measuring baking/cooking ingredients as well as similar improvements in yield and accuracy of other materials dispensing applications. It is a still further advantage of the preferred embodiments of the system to seamlessly integrate into existing food serving equipment and processes without affecting the existing food serving and material handling equipment and processes. In addition, it is an advantage of the preferred embodiments of the system to provide a highly automated food serving and materials portion data acquisition and processing system.

Additional advantages of the preferred embodiments of the invention will become apparent from an examination of the drawings and the ensuing description.

### EXPLANATION OF THE TECHNICAL TERMS

The use of the terms “a,” “an,” “the,” and similar terms in the context of describing the invention are to be construed to cover both the singular and the plural, unless otherwise indicated herein or clearly contradicted by context. The terms “comprising” “having,” “including,” and “containing” are to be construed as open-ended terms (i.e., meaning “including, but not limited to,”) unless otherwise noted. The terms “substantially,” “generally,” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

Terms concerning attachments, coupling and the like, such as “attached,” “connected,” and “interconnected,” refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as,” “preferred,” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY OF THE INVENTION

The apparatus of the invention comprises a yield improvement system adapted to weigh an object. The preferred yield improvement system comprises a weighing device having a holder that is adapted to removably receive the object to be weighed and a load sensor that is adapted to determine the weight of the object to be weighed. The preferred yield system also comprises a programmable logic controller that is in electrical communication with the weighing device, a cloud platform that is in electrical communication with the programmable logic controller, and an application program interface (API) that is in electrical communication with the cloud platform, and a means for removably attaching the weighing device to an anchoring device.

The method of the invention comprises providing a yield improvement system adapted to weigh an object. The preferred yield improvement system comprises a weighing device having a holder that is adapted to removably receive the object to be weighed and a load sensor that is adapted to determine the weight of the object to be weighed. The preferred yield system also comprises a programmable logic controller that is in electrical communication with the weighing device, a cloud platform that is in electrical communication with the programmable logic controller, and an application program interface (API) that is in electrical communication with the cloud platform, and a means for removably attaching the weighing device to an anchoring device. The preferred method also comprises weighing the object.

### BRIEF DESCRIPTION OF THE DRAWINGS

The presently preferred embodiments of the invention are illustrated in comestible dispensing applications the accompanying drawings, in which like reference numerals represent like parts throughout, and in which:

FIG. 1 is a schematic diagram illustrating architecture of the yield improvement system in accordance with the present invention.

FIG. 2 is a perspective view of the preferred embodiment of the digital weigh scale with connected solar power supply, audio/video notification device and data processing device mounted in French fries serving area.

FIG. 3 is an isolated perspective view of the preferred embodiment of the digital weigh scale device with a bag of French fries sitting in the customized holder illustrated in FIG. 2.

FIG. 4 is an isolated perspective view of the preferred embodiment of the digital weigh scale for use with French fries illustrated in FIGS. 2-3.

FIG. 5 is an isolated perspective view of the preferred embodiment of digital weigh scale illustrated in FIGS. 2-4 shown without an enclosure.

FIG. 6 is an exploded perspective view of the preferred embodiment of digital weigh scale illustrated in FIGS. 2-5.

FIG. 7 is a perspective view of a first alternative embodiment of digital weigh scale adapted for use for calibration of liquid dispensers in accordance with the present invention.

FIG. 8 is a schematic view of the preferred embodiment of the digital weigh scale visual indications.

### DESCRIPTION OF THE PREFERRED EMBODIMENTS OF THE INVENTION

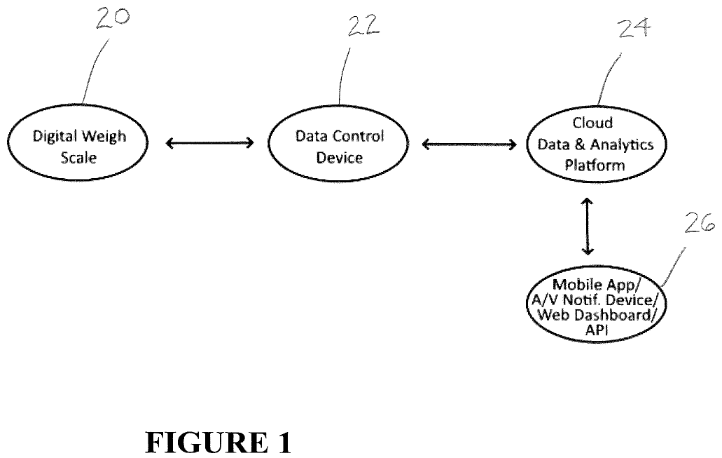

Referring now to the drawings, the preferred embodiment of the yield improvement system in accordance with the present invention is illustrated by FIGS. 1 through 8. As shown in FIGS. 1-8, the preferred yield improvement system is directed to system and method for improving accuracy and yield of food servings and other apportioned materials. The system preferably comprises the following components: digital weigh scale, data processing device, cloud data and analytics platform, on-site visual and audio notification device, Web Dashboard and mobile app. These components are related as follows: digital weigh scale is installed in the food serving assembly area or other material dispensing area; digital scale weighs every food comestible or other material to be included in the food serving or materials portion; operation of the scale is controlled by the data processing device; data processing device is tracking all aspects of food portioning performance, and finally the system exchanging this data with the cloud data and analytics platform that processes such data to generate variety of performance metrics, corrective actions and any other types of notifications and interactions, that can be transmitted to operators or other personnel with on-site visual and audio notification devices (e.g. Tablet and Wireless Speaker connected to the AI driven Cloud Platform). Visual/audio notification components and voice commands, generated by the system, are additionally used to improve operator performance related to all other systems in the store/facility (e.g. commands to turn off/on equipment at specific times, change equipment operation modes, reminders and instructions to improve regular routines/processes, assistance with order processing, messages to boost team/operator morale and productivity, training, etc.). System also allows management to make audio/video calls to the on-site visual and audio notification device(s) for interactions with personnel and/or training. Web Dashboard and Mobile app provide access to the cloud data and analytics platform functionality for customers/users. It should further be noted that to optimize portability of the scale and provide required ease of cleaning, scale has a clamp at the base and two magnets on the serving holder (for easy attachment and detachment of said holder). The scale has an audio signaling component as well as a visual indication component (LED/LCD display) to provide notifications to operator.

In order to automate operation and minimize the required interaction with an operator, the preferred scale is adapted to automatically:
1. tare weight,
2. adjust zero drift using embedded temperature and firmware compensation,
3. execute self-calibration routine for increased measurement precision,
4. detect the type of serving packaging and size of target portion,
5. calibrate liquid dispensers/shake machines by weight through use of embedded functionality,
6. measure baking/cooking ingredients,
7. prevent the overfilling and/or holding of more product than specified by use of system's holder designs,
8. power and charge the scale and data processing device by the battery power source rechargeable with the portable solar panel, that collects energy from heating and/or ambient lamps,
9. aggregate massive amounts of operational and performance data for cloud data and analytics platform, which in turn uses proprietary smart software algorithms, AI-analysis, and self-learning software models to provide unique visibility of the serving apportionment operations, automatically calculates yield, served portions, calorie count of each individual food serving and other associated metrics/benefits,
10. visually present/illustrate data, metrics, notifications to personnel for corrective actions and improvements (including voice commands and virtual training), and various other alerts and information provided to improve operations/product yield/quality/safety
11. generate performance reports, assessing operator performance/accuracy, comparison with operator ranking, and calculating product savings and/or loss.
   The preferred method associated with the disclosed system comprises the following steps:
   1) Mounting the digital weigh scale in the food assembly or other material dispensing area. The preferred scale has an affixed food serving support structure/holder.
   2) Placing a serving container on the scale supporting structure/holder
   3) The preferred digital weigh scale automatically recognizes the container and assigns the target portion size by a combination of following methods:
   3.a) Food serving or apportioned material container is automatically weighed. Proprietary firmware and cloud data and analytics platform automatically analyzes and assigns the specified target portion size
   3.b) Operator issues a command to define the target portion size. Acceptable methods of delivering command include voice, motion, touch, contact and non-contact interactions.
   3.c) Required target portion size, along with additional data is obtained through multiple data communication channels with POS, order tracking, inventory tracking personnel tracking, and backend and other external data processing systems related to the operation of restaurant/facility.
   4) Filling the serving container with comestibles/materials up to the required portion size
   4.a) Automatically weighing the container and its contents while the container is being filled
   4.b) Obtaining audio and/or visual indications to improve filling accuracy and enhance performance
   4.c) Automatically collecting and exchanging operational data with the cloud data and analytical platform for further processing, analysis, and representation
   5) Removing assembled serving from the digital scale and transitioning it to the next area. It should further be noted that operational data is preferably automatically collected at all times, capturing not only active usage of the system but also system idle operation. Furthermore, audio and visual indication components that are part of the digital scale can be used to deliver various information generated by the cloud data and analytical platform (e.g. notifications, performance scores, marketing and promotions).

FIG. 1 is a schematic diagram that illustrates the architecture of system for yield improvement. Digital Weigh Scale 20 is exchanging its performance data and is being controlled by Data Control/Processing Device 22 that communicates with Cloud Data and Analytics Platform 24. Users can access information with Mobile App, Audio/Video Notification Device, Web Dashboard, API Interface 26.

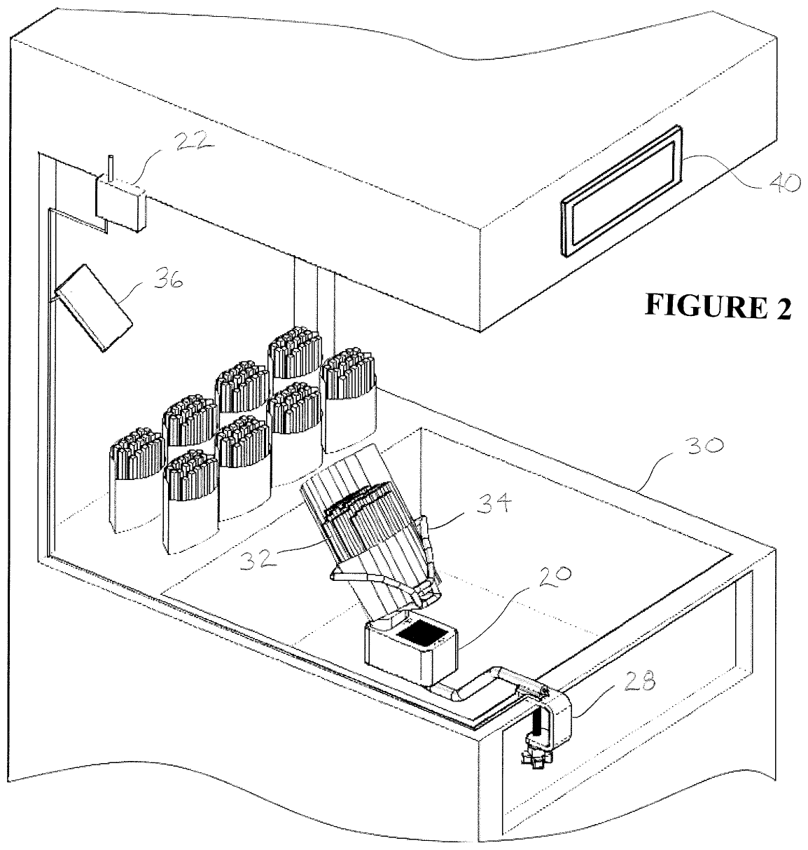

FIG. 2 shows one particular exemplary embodiment of Digital Weigh Scale 20 sitting on the Scale Base 28 affixed to the French fries serving equipment 30. Digital Weigh Scale 20 is demonstrated with a bag of French fries 32 sitting in Serving Holder 34, being weighed and with wired connection to Solar Panel 36 and Data Control/Processing Device 22. Audio/Video Notification device 40 (E.g. tablet connected to Cloud) is mounted above serving area to interact with restaurant personnel.

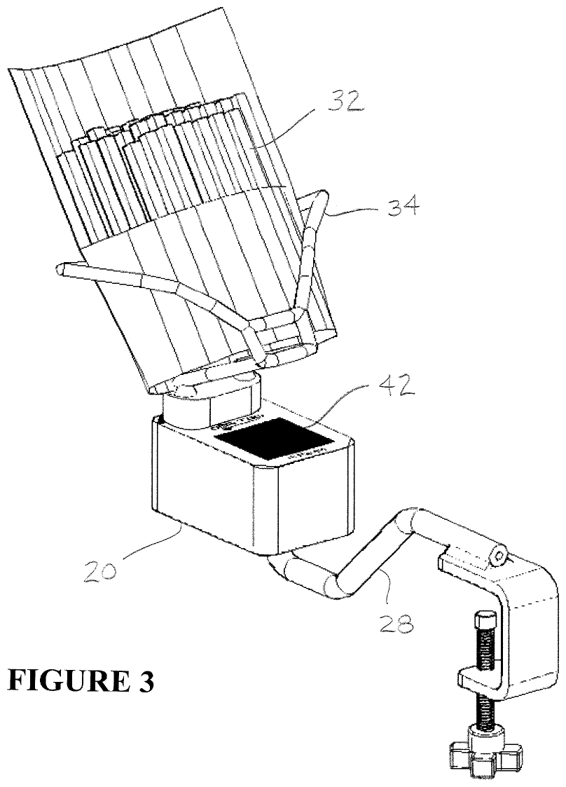

FIG. 3 shows one particular exemplary embodiment of Digital Weigh Scale 20 used to improve yield of French fries' servings. Bag of French fries 32 is sitting in the Serving Holder 34. Uniquely customized shape of Serving Holder 34 physically does not allow Bag of French Fries 32 to overly expand in size and hold more product than required. Scale Base 28 has an extended support tubing that positions Digital Weigh Scale 20 in the optimal location to facilitate operator's usage, also tubing provides protection for the data cable running inside it. Shape and design of Scale Base 28 can be customized for each individual application. Display 42 is used to provide visual indication to the operator.

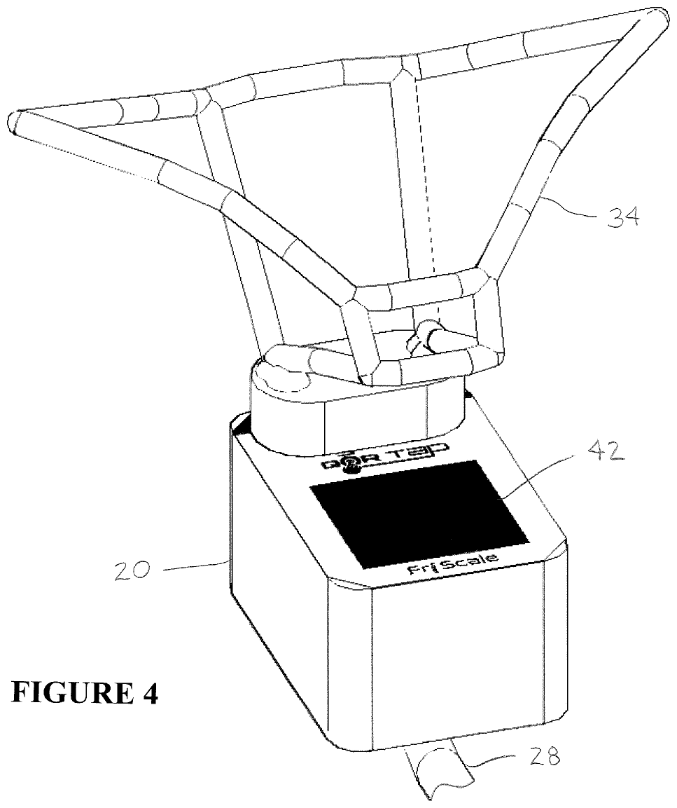

FIG. 4 shows one particular exemplary embodiment of Digital Weigh Scale 20 used to improve yield of French fries' servings. Serving Holder 34 is used to provide support for food servings being weighed. Serving Holder 34 is magnetically attached to the top surface of the Digital Weigh Scale 20, can be easily removed for cleanability. Also, such attachment method provides breakage/damage protection against accidental exposure to increased side forces to the Serving Holder 34, and further transmission of such forces to the sensitive internal components of the Digital Weigh Scale 20. Display 42 is used to provide visual indication to the operator.

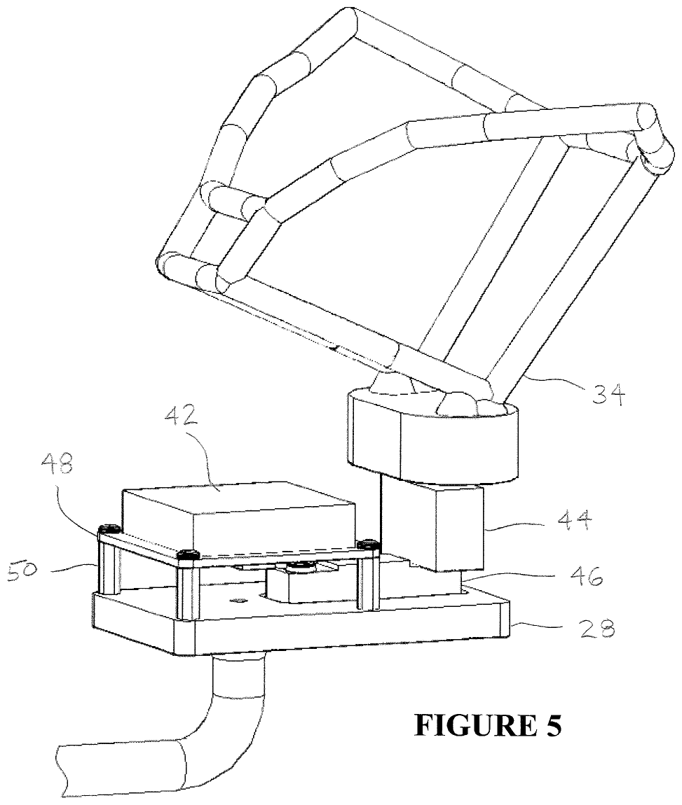

FIG. 5 shows one particular exemplary embodiment of Digital Weigh Scale 20 used to improve yield of French fries' servings with enclosure removed. Serving Holder 34, with two embedded magnets is attached to the magnetic Spacer 44, which is affixed to the Load Sensor 46 that is affixed to the Scale Base 28 at its other end. Display 42 is mounted on the Scale MCU board 48, sitting on Spacers 50. Optional internal audio speaker will be located on the rear side of Scale MCU board 48.

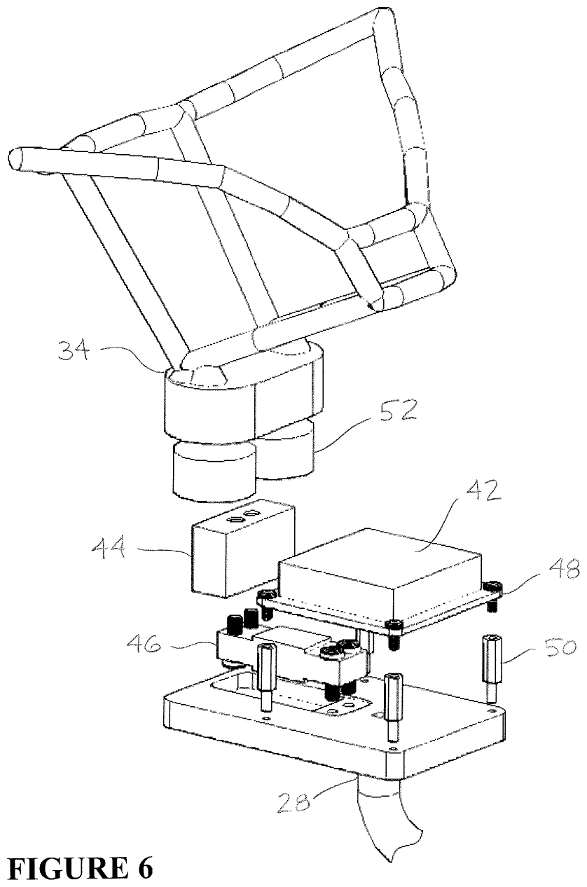

FIG. 6 shows one particular exemplary embodiment of Digital Weigh Scale 20 used to improve yield of French fries' servings, in exploded view. Serving Holder 34, has two embedded Magnets 52, located inside its base. Utilization of two magnets prevents the Serving Holder 34 from free rotation on the scale and enables self-positioning against the magnetic Spacer 44, residing under the scale enclosure. Spacer 44 is affixed to the Load Sensor 46 which is affixed to the Scale Base 28 at its other end. Display 42 is mounted on the Scale MCU board 48, sitting on Spacers 50. Optional internal audio speaker will be located on the rear side of Scale MCU board 48

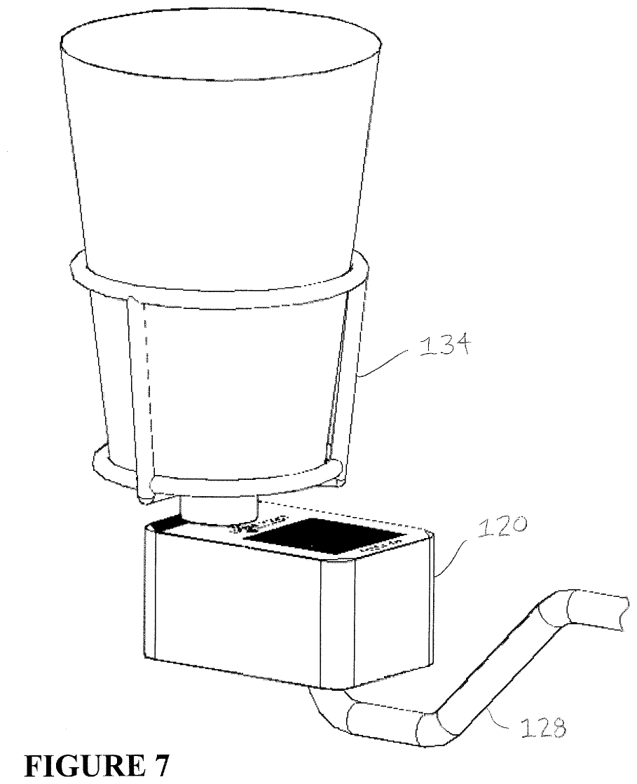

FIG. 7 shows one particular exemplary embodiment of Digital Weigh Scale 120, to use for calibration of liquid dispensers. Serving Holder 134, has uniquely customized shape to accommodate a measuring cup that holds a required amount of liquid product. Serving Holder 134 is magnetically attached to the top surface of the Digital Weigh Scale 120, sitting on the Scale Base 128, and can be easily interchanged with other Serving Holders for French fries or other food/materials serving containers.

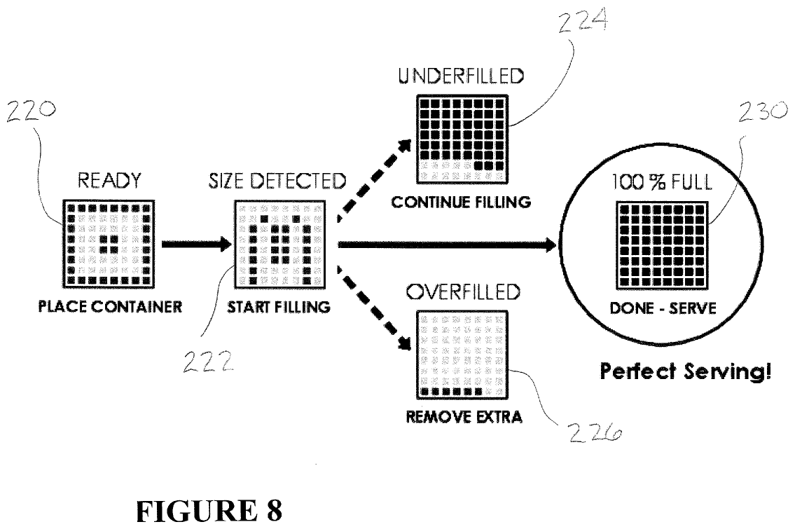

FIG. 8 shows one particular exemplary embodiment of digital weigh scale visual indications, matching the disclosed yield improvement method. Scale Ready condition 220 tells operator that digital weigh scale automatically performed required firmware and cloud data processing and is ready for apportioning procedure. Food serving container could be placed on the affixed food serving support structure/holding. For the next step of yield improvement method, digital weigh scale automatically assigns the target portion size and notifies operator with Size Detected condition 222. While said container is being filled it is automatically weighed and operator obtains audio and/or visual indications to improve filling accuracy. Instead of providing a numeric value for the portion weight, that would require operator to memorize various required portions and interpret the value in order to dispense the exact amount of product, utilization of disclosed yield improvement system and method allows to achieve very accurate and intuitively easy apportionment by informing operator with pre-processed, simplified audio/visual indication that food serving is in Underfilled condition 224 (E.g. green colored dots), or Overfilled condition 226 (E.g. red colored dots) or food serving is at exact required size in 100% Full condition 230 (E.g. green colored dots) and said food serving could be removed from the digital scale and transitioned to the next area.

Disclosed is a system together with an associated data acquisition and processing method. The system is made up of the following components: digital weight scale, data processing device, cloud data & analytics platform. These components are related as follows: digital weight scale, its performance and parameters are controlled by the data processing device that collects the scale usage data, regulates operation of the scale, processes aggregated data and exchanges this data with the cloud data and analytics platform. Cloud data and analytics platform comprises software components which perform manipulations of digital weight scale data: data processing, data analytics, visual representation, AI-learning, notifications, alarms, generation of corrective actions, voice commands, performance reports/comparison, ranking, making available such features at a local or remote level.

Also disclosed is a method to collect food serving weight and apportioned material data in an unobtrusive way:

1) Placing a digital weight scale with affixed food serving or apportioned material supporting surface/structure in food serving assembly or apportioned material area

2) Placing food serving or apportioned material container on the supporting surface/structure

3) Automatically choosing the target portion size by one or a combination of following methods:
a) Weighing said food serving or apportioned material container to automatically choose target portion size required for that specific container
b) Receiving a command from the operator who is using the digital weigh scale system
c) Integration with POS, Order tracking or other external data system

4) Filling container with comestibles or apportioned material to the specified portion amount:
a) By weighing container and product while it is being filled
b) Providing visual and/or audio indication of weight to the operator
c) Automatically collecting weight and performance data for further processing and analytics.

5) Moving assembled serving to the release area or area for further processing.

Data processing device and digital weigh scale may be connected with hardwired connection, wireless connection, or embedded into a single unit comprising system System-on-a-Chip (SoC); depending on the optimal installation requirements.

Data processing device and digital weigh scale system architecture allow for multiple installation methods to accommodate various food serving equipment and processes that are used in the restaurant environment as well as for material dispensing in commercial/industrial applications. For example, they may be temporarily attached to the preparation equipment (e.g. with magnets, clamps) to allow portability and easy cleaning, permanently affixed to the surface of such equipment, embedded into the equipment itself, or situated nearby apportioning equipment or serving area.

Power for data processing device and digital weigh scale may be provided with mains power source, battery with or without rechargeable power source, and/or solar panel that may collect light from the existing lighting/heating sources. The preferred data processing device may exchange data with the cloud data & analytics platform with a wired or wireless connection. The preferred digital weigh scale is designed to accommodate various container shapes and sizes so it is applicable for any food product (e.g. French fries, pizza, onion rings, etc.) or material. Weight measurement from the load sensor will typically drift with change in ambient temperature. It is typical for restaurant kitchen and commercial/industrial environments to experience high temperatures, so digital weigh scale may utilize embedded temperature sensing functionality to automatically compensate and correct such drift. In order to improve the weight measurement accuracy of the digital weigh scale that drifts over time, the system may automatically or manually initiate a calibration process, that may involve placement of any known weight (e.g. food serving packaging) on the weigh scale and running a self-calibration routine. In order to improve the performance of food serving weight measurements and to minimize required interactions with operators, the digital weigh scale may automatically tare the weight reading, may automatically adjust zero drift, and may automatically detect when and what container is placed on the scale or removed from it.

To further improve interactions with operators and maximize technology adoption level, yield improvement system has additional visual and audio notification components (LCD Display, Tablet, All-in-one PC, Wireless Speaker, etc.) that may generate sounds, voice commands and/or messages to interact with operators and improve their performance (e.g. filling accuracy, performance metrics, alarm notifications, messages and video/audio calls from management, video training, etc.). It should be further noted, that system visual/audio notification components and voice commands could be additionally used to improve operator performance related to all other systems in the store/facility (e.g. commands to turn off/on equipment at specific times, change equipment operation modes, reminders and instructions to improve regular routines/processes, assistance with order processing, messages to boost team/operator morale and productivity, training, etc.). Such sounds, messages and/or voice commands may be generated with local data processing at the use site or with data processing occurring in the cloud data and analytics platform (e.g. with AI-driven functionality).

To allow complete visibility of the food serving assembly and material dispensing process and generate corrective actions for performance improvement, data in the cloud data and analytical platform may be accessible via a web portal, mobile app, locally through visual and audio notification components or external data system through API integration. Cloud data and analytics platform may analyze data to automatically calculate yield, served portions, calorie count of each individual food serving, and other associated metrics/benefits.

The disclosed system is unique when compared with other conventional systems because it provides:

(1) automatic detection of the serving container size;

(2) automatic calibration using serving container as a calibration weight;

(3) automatic compensation for the load sensor zero drift with embedded temperature sensing;

(4) magnetic grip of the serving container holder, making it easily detachable to avoid potential breakage or damage, and allow ease of cleaning;

(5) fully customizable audio and/or visual indications (including voice commands) embedded in the yield improvement system that can deliver information generated by the cloud data and analytical platform;

(6) automatic collection of the serving apportionment performance data with its further processing in the cloud data and analytics platform; and

(7) holders for serving containers could have uniquely customized designs to accommodate variety of containers to help prevent expending and/or holding more product than specified.

Similarly, the associated method is unique when compared to other conventional systems in that it (1) does not interfere with existing serving assembly processes and procedures; and (2) automatically collects telemetry data during such processes.

The disclosed system is superior to conventional systems because collection and further processing of digital weigh scale data in the cloud data and analytical platform allows for aggregating massive amounts of very detailed serving apportionment data. Such data when processed and analyzed with proprietary smart software algorithms, self-learning data models, and AI-processing engines can improve product yield and provide complete visibility of the serving operations on a large and expandable scale. It can also significantly improve technology adoption level by automatically interacting with system operators through data platform driven visual and audio notification components.

The apparatus of the invention comprises a yield improvement system adapted to weigh an object. The preferred yield improvement system comprises a weighing device having a holder that is adapted to removably receive the object to be weighed and a load sensor that is adapted to determine the weight of the object to be weighed. The preferred yield system also comprises a programmable logic controller that is in electrical communication with the weighing device, a cloud platform that is in electrical communication with the programmable logic controller, and an application program interface (API) that is in electrical communication with the cloud platform, and a means for removably attaching the weighing device to an anchoring device.

The preferred system further comprises a solar energy generation source that is operatively connected to the programmable logic controller, a notification device that provides an audio notification and/or a video notification and has a display. In the preferred system, the means for removably attaching the weighing device to the item of equipment comprises an extendable tube, the holder comprises a magnet and/or a holder spacer, the weighing device comprises a weighing device spacer and/or a microcontroller unit (MCU), and the microcontroller unit (MCU) comprises a speaker.

The method of the invention comprises providing a yield improvement system adapted to weigh an object. The preferred yield improvement system comprises a weighing device having a holder that is adapted to removably receive the object to be weighed and a load sensor that is adapted to determine the weight of the object to be weighed. The preferred yield system also comprises a programmable logic controller that is in electrical communication with the weighing device, a cloud platform that is in electrical communication with the programmable logic controller, and an application program interface (API) that is in electrical communication with the cloud platform, and a means for removably attaching the weighing device to an anchoring device. The preferred method also comprises weighing the object. The preferred method further comprises providing notification that the yield improvement system is ready to receive a container, providing notification that the yield improvement system has detected the size of the container, providing notification that the container is under-filled, providing notification that the container is over-filled, and providing notification that the container is properly filled.

In operation, several advantages of the preferred embodiments of the yield improvement system are achieved. For example, the preferred embodiments of the system significantly improve filling accuracy. In food dispensing application the system eliminated recurring overfill of food portions, resulting in ˜30% reduction in food product usage and generating average monthly food cost savings of 500 US dollars. Visual quality of assembled food serving also improved, due to more consistent and accurate distribution of food within the serving container. Embedded voice command functionality alerted and instructed restaurant operators how to optimize usage of electric cooking equipment thereby resulting in ˜20% reductions in daily power usage, leading to average monthly electricity cost savings of 700 US dollars. Intuitiveness and high automation of the system serves to train restaurant system operators in less than 5 minutes. Training and support functions embedded in the system utilize its audio/video capability to train operators from multiple (unlimited) stores during the same virtual training session. Utilization of cloud data and analytics platform provides for 100% visibility into all aspects of the system usage and generated benefits. Voice command functionality embedded in the system provides automatic control of system usage rate and improvement of other store operations by verbally interacting with store operators, monitoring operator's consistent use of system, and realizing additional savings from operations improvement.

The disclosed system is superior to other systems because collection and further processing of digital weigh scale data in the cloud data and analytical platform allows for aggregating massive amounts of very detailed serving and materials apportionment data. Such data when processed and analyzed with proprietary smart software algorithms, self-learning data models, and AI-processing engines can improve product yield and provide complete visibility of the serving and materials processing operations on a large and expandable scale. It can also significantly improve technology adoption level by automatically interacting with system operators through data platform driven visual and audio notification components.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

This disclosure provides a detailed and specific description with the accompanying drawings. The drawings and specific descriptions of the drawings, as well as any specific or alternative embodiments discussed, are intended to be read in conjunction with the entirety of this disclosure. The system may, however, be embodied in many different forms and should not be construed as being limited to the embodiments set forth herein; rather, these embodiments are provided by way of illustration only and so that this disclosure will be thorough, complete, and fully convey understanding to those skilled in the art.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A yield improvement system adapted to weigh an object, said yield improvement system comprising:
(a) a weighing device, said weighing device comprising:
(1) a holder, said holder being adapted to removably receive the object to be weighed;
(2) a load sensor, said load sensor being adapted to determine the weight of the object to be weighed;
(b) a programmable logic controller, said programmable logic controller being in electrical communication with the weighing device;
(c) a cloud platform, said cloud platform being in electrical communication with the programmable logic controller;
(d) an application program interface (API), said application program interface (API) being in electrical communication with the cloud platform;
(e) a means for removably attaching the weighing device to an anchoring device.

2. The yield improvement system of claim 1 further comprising a solar energy generation source, said solar energy generation source being operatively connected to the programmable logic controller.

3. The yield improvement system of claim 1 further comprising a notification device.

4. The yield improvement system of claim 3 wherein the notification device provides an audio notification.

5. The yield improvement system of claim 3 wherein the notification device provides a video notification.

6. The yield improvement system of claim 1 wherein the weighing device comprises a display.

7. The yield improvement system of claim 1 wherein the means for removably attaching the weighing device to the item of equipment comprises an extendable tube.

8. The yield improvement system of claim 1 wherein the holder comprises a magnet.

9. The yield improvement system of claim 1 wherein the holder comprises a holder spacer.

10. The yield improvement system of claim 1 wherein the weighing device comprises a weighing device spacer.

11. The yield improvement system of claim 1 wherein the weighing device comprises a microcontroller unit (MCU).

12. The yield improvement system of claim 11 wherein the microcontroller unit (MCU) comprises a speaker.

13. A method for improving the yield of a weighed object, said method comprising:
(a) providing a yield improvement system adapted to weigh an object, said yield improvement system comprising:
(1) a weighing device, said weighing device comprising:
(i) a holder, said holder being adapted to removably receive the object to be weighed;
(ii) a load sensor, said load sensor being adapted to determine the weight of the object to be weighed;
(2) a programmable logic controller, said programmable logic controller being in electrical communication with the weighing device;
(3) a cloud platform, said cloud platform being in electrical communication with the programmable logic controller;
(4) an application program interface (API), said application program interface (API) being in electrical communication with the cloud platform;
(5) a means for removably attaching the weighing device to an anchoring device;
(b) weighing the object.

14. The method of claim 13 further comprising providing notification that the yield improvement system is ready to receive a container.

15. The method of claim 13 further comprising providing notification that the yield improvement system has detected the size of the container.

16. The method of claim 13 further comprising providing notification that the container is under-filled.

17. The method of claim 13 further comprising providing notification that the container is over-filled.

18. The method of claim 13 further comprising providing notification that the container is properly filled.
